(19) United States
(12) Patent Application Publication
(10) Pub. No.: US 2014/0122302 A1
(43) Pub. Date: May 1, 2014

(54) Customized Data Delivery

(71) Applicants: AT&T INTELLECTUAL PROPERTY I, L.P., Atlanta, GA (US); AT&T MOBILITY II LLC, Atlanta, GA (US)

(72) Inventors: Mostafa Tofighbakhsh, Cupertino, CA (US); Mike Iapalucci, Carrollton, TX (US)

(73) Assignees: AT&T MOBILITY II LLC, Atlanta, GA (US); AT&T INTELLECTUAL PROPERTY I, L.P., Atlanta, GA (US)

(21) Appl. No.: 13/666,039

(22) Filed: Nov. 1, 2012

(51) Int. Cl. G06F 3/01; G06F 15/16; G06Q 30/00

(52) U.S. Cl. 705/27.1; 715/748

(57) ABSTRACT

Concepts and technologies are described herein for customized data delivery. An illustrative source device is configured to send data content to a destination device over a data delivery network. The source device can present a data delivery user interface on a display. The data delivery user interface may show a plurality of data delivery options available to a user of the source device and received from a data delivery management system. The source device can receive an input associated with delivery of the data content to the destination device. The input may include the selection of a delivery option from the plurality of data options. Alternatively, the input may include user-defined delivery specifications. The source device can generate a delivery record request including the input, send the delivery record request to the data delivery management system, and receive a delivery record response from the data delivery management system.

### TECHNICAL FIELD

The concepts and technologies disclosed herein generally relate to data networks. More specifically, the concepts and technologies disclosed herein relate to providing customized data delivery via one or more data networks.

### BACKGROUND

In recent years, mobile telecommunications carriers have experienced a dramatic increase in data usage on their networks. This increase in data usage has been caused in part by the increased adoption of smartphones and other devices that utilize data network resources. Currently, it is common for users to download or upload data content, such as movies, images, applications, and the like, that range in size from a few megabytes to a gigabyte or more. This places a substantial burden on a mobile telecommunications carrier's data network.

Mobile telecommunications carriers typically provide subscription-based data plans that allow a subscriber to select from various predefined amounts of data to be replenished on a monthly basis. Some mobile telecommunications carriers also provide pre-paid data options that do not require a subscription to access a pre-paid amount of data. Data network users are permitted to access data resources of a mobile telecommunications carrier's data network via their device(s) within the constraints set forth by their subscription data plan or pre-paid amount of data. Users may desire to access these data resources when and/or where the carrier's data network is congested thereby increasing the network resources needed to provide data service and also increasing the associated costs.

### SUMMARY

Concepts and technologies are described herein for customized data delivery. According to one aspect disclosed herein, an illustrative source device includes a display, a processor, and a memory including instructions that, when executed by the processor, cause the processor to perform operations. The operations can include presenting a data delivery user interface on the display, receiving, via the data delivery user interface, input associated with delivery of data content to a destination device, generating a delivery record request that includes the input, sending the delivery record request to a data delivery management system, and receiving a delivery record response from the data delivery management system.

According to another aspect disclosed herein, a data delivery management system includes a processor and a memory including instructions that, when executed by the processor, cause the processor to perform operations. The operations can include providing a plurality of data delivery options to a source device configured to initiate delivery of data content to a destination device and receiving a delivery record request from the source device. The delivery record request can include a selection of a data delivery option from the plurality of data delivery options. The operations can also include generating a delivery route by which to deliver the data content to the source device and sending the delivery route to a data delivery network through which delivery of the data content from the source device to the destination device is to be at least partially performed.

According to another aspect disclosed herein, an illustrative method includes receiving, at a data delivery management system, network performance data, defining, by the data delivery management system, a plurality of data delivery options based upon the network performance data, and sending, by the data delivery management system, the plurality of data delivery options to a source device configured to initiate delivery of data content to a destination device.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative operating environment for various concepts disclosed herein.

FIG. 2 is a flow diagram illustrating aspects of a method for providing a data delivery user interface, according to an illustrative embodiment.

FIG. 3 is a flow diagram illustrating aspects of a method for providing data delivery options to a device, according to an illustrative embodiment.

FIG. 4 is a flow diagram illustrating aspects of a method for providing a data delivery user interface, according to an illustrative embodiment

FIG. 5 is a flow diagram illustrating aspects of a method for providing a collect data delivery option via a data delivery user interface, according to an illustrative embodiment.

FIG. 6 is a flow diagram illustrating aspects of a method for providing a data receipt user interface, according to an illustrative embodiment.

FIG. 7 is a flow diagram illustrating aspects of a method for handling collect data delivery notifications, according to an illustrative embodiment.

FIG. 8 is a user interface diagram illustrating aspects of a data delivery user interface, according to an illustrative embodiment.

FIG. 9 is a computer architecture diagram illustrating an illustrative computer hardware and software architecture for a computing system capable of implementing aspects of the embodiments presented herein.

FIG. 10 is a mobile device architecture diagram illustrating an illustrative mobile device hardware and software architecture for a mobile device capable of implementing aspects of the embodiments disclosed herein.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer system configurations, including hand-held devices, mobile devices, wireless devices, multiprocessor systems, distributed computing systems, microprocessor-based or programmable consumer electronics, minicomputers, mainframe computers, routers, switches, and the like.

In the following detailed description, references are made to the accompanying drawings that form a part hereof, and in which are shown by way of illustration specific embodiments or examples. Referring now to the drawings, in which like numerals represent like elements throughout the several figures, example aspects of customized data delivery will be presented.

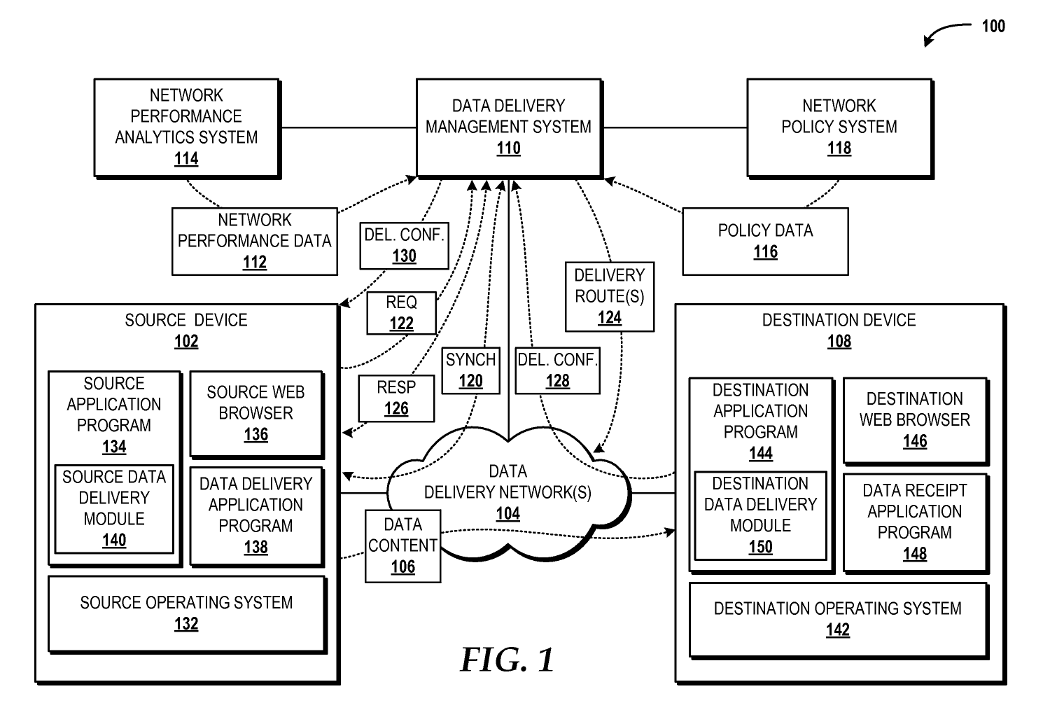

Referring now to FIG. 1, aspects of an illustrative operating environment 100 for various concepts disclosed herein will be described. It should be understood that the operating environment 100 and the various components thereof have been greatly simplified for purposes of discussion. Accordingly, additional or alternative components of the operating environment 100 can be made available without departing from the embodiments described herein.

The operating environment 100 shown in FIG. 1 includes a source computing device (“source device”) 102 operating on or in communication with one or more data delivery networks 104 (hereinafter, at times, referred to collectively or generically as “data delivery network 104”) through which the source device 102 can deliver data content 106 to one or more destination computing devices including a destination computing device (“destination device”) 108 in accordance with various aspects disclosed herein. The data content 106 may include any data of any size and in any format. In some embodiments, the data content 106 includes text, image(s), video(s), application program(s), metadata, any combination thereof, and/or the like.

The source device 102 and the destination device 108 may be a cellular telephone, a smartphone, a mobile computer, a tablet computer, a desktop computer, a television, a video game console, a handheld video game console, a set-top box system, or any other computing device that is configured to send data to and receive data from one or more data networks, such as the data delivery network 104. In some embodiments, the data delivery network 104 includes one or more mobile telecommunications networks. As such, the source device 102 and/or the destination device 108 can include an integrated or external access component that facilitates wireless communication with a mobile telecommunications network. The access component may be a cellular telephone that is in wired or wireless communication with the source device 102 or the destination device 108 to facilitate a tethered data connection to a mobile telecommunications network. Alternatively, the access component includes a wireless transceiver configured to send data to and receive data from a mobile telecommunications network and a universal serial bus (“USB”) or another communication interface for connection to the source device 102 or the destination device 108 to enable tethering. In any case, the source device 102 can wirelessly communicate with a mobile telecommunications network over an air interface in accordance with one or more radio access technologies to send the data content 106 to the destination device 108, and the destination device 108 can wirelessly communicate with a mobile telecommunications network over an air interface in accordance with one or more radio access technologies to receive the data content 106 from the source device 102. The source device 102 and/or the destination device 108 may also initiate, receive, and/or maintain voice calls with one or more other devices (not shown). The source device 102 and/or the destination device 108 may also exchange Short Message Service (“SMS”) messages, email, and/or other messages with other devices (not shown).

A mobile telecommunications network, as used herein, includes one or more radio access networks (“RANs”). A mobile telecommunications network also includes a wireless wide area network (“WWAN”), which may, in turn, include a circuit-switched core network (“CS CN”), a packet-switched core network (“PS CN”), and/or an IP multimedia subsystem (“IMS”) core network. The WWAN can utilize one or more mobile telecommunications technologies to provide voice and/or data services via one or more RANs to a WWAN component (not shown) of the source device 102 and/or the destination device 108. The mobile telecommunications technologies may include, but are not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other 802.XX technologies, and/or the like. A RAN can utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and/or the like to provide an air interface to the source device 102 and/or the destination device 108. A RAN may be a GSM RAN (“GRAN”), a GSM EDGE RAN (“GERAN”), a UMTS Terrestrial Radio Access Network (“UTRAN”), an E-UTRAN, any combination thereof, and/or the like. The source device 102 and/or the destination device 108 can communicate with one or more RANs that utilize the same or different radio access technologies. As such, in some embodiments, the source device 102 and/or the destination device 108 are multi-mode communications devices.

Data communications can be provided by a mobile telecommunications network using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. A mobile telecommunications network may be configured to provide voice and/or data communications with any combination of the above technologies. A mobile telecommunications network may be configured to or adapted to provide voice and/or data communications in accordance with future generation technologies.

In some embodiments, the data delivery network 104 includes one or more wireless networks that each operate in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as “WI-FI”). Draft 802.11 standards are also contemplated. A WI-FI network may be implemented utilizing one or more wireless WI-FI access points. In some implementations, one or more of the wireless WI-FI access points is a mobile device or other computing device that functions as a WI-FI hotspot. In some implementations, the source device 102 and/or the destination device 108 connects to a WI-FI network via one or more secure connections, each of which may utilize an encryption technology such as, but not limited to, WI-FI Protected Access (“WPA”), WPA2, Wired Equivalent Privacy (“WEP”), or the like. In some embodiments, the data delivery network 104 includes one or more wireline data networks to which the source device 102 and/or the destination device 108 connects via a wired connection such as, but not limited to, IEEE 802.3 (“Ethernet”).

In some embodiments, the data delivery network 104 includes one or more wired and/or wireless personal area networks (“PANs”), one or more wired and/or wireless body area networks (“BANs”), one or more wired and/or wireless metropolitan area networks (“MANs”), one or more wired and/or wireless wide area networks (“WANs”), one or more wired and/or wireless campus area networks (“CANs”), and/or one or more wired and/or wireless local area networks (“LANs”). Accordingly, the data delivery network 104 is used broadly herein describe any number of wired and/or wireless networks through which the data content 106 can be delivered from the source device 102 to the destination device 108. It should be understood that the data delivery network 104 may include one or more networks to which the source device 102 and/or the destination device 108 do not communicate directly.

The operating environment 100 also includes a data delivery management system 110. The data delivery management system 110 provides one or more data delivery options to the source device 102. A data delivery option is provided to a user of the source device 102 to choose when and how the data content 106 is to be delivered to the destination device 108. As such, a data delivery option may identify a time at which the data content 106 is to be delivered to the destination device 108. The time at which the data content 106 is to be delivered to the destination device 108 includes the time instance at which the data content 106 is to be received by the destination device 108 or a time period during which the data content 106 is to be received by the destination device 108 assuming the destination device 108 is in a state capable of receiving the data content 106. In other words, the destination device 108 has sufficient power (e.g., battery life or plugged in to a power source) to receive the data content 106 and sufficient connectivity to the data delivery network 104 to receive the data content 106. Other considerations regarding the capability of the destination device 108 to receive the data content 106 are contemplated, such as, but not limited to, the number of data blocks available to a user of the destination device 108 as specified by a subscription data plan or a pre-paid data plan.

A data delivery option may alternatively or additionally identify a data delivery network to which the source device 102 is to be connected in order to initiate delivery of the data content 106 to the destination device 108. Similarly, a data delivery option may alternatively or additionally identify a data delivery network to which the destination device 102 is to be connected in order to receive the data content 106. In some embodiments, the data delivery management system 110 instructs the destination device 108 to connect to a particular data delivery network in order to receive the data content 106.

A data delivery option may alternatively or additionally identify one or more security conditions under which the source device 102 and/or the destination device 108 must be in order to send and receive the data content 106, respectively. In some embodiments, a security condition includes a requirement that the source device 102 or the destination device 108 be connected to a data delivery network that is encrypted, and possibly a further requirement that the encryption is provided by a certain encryption technology such as any of the encryption technologies described above, combinations thereof, and/or the like. For example, the data delivery option may identify the destination device 108 as having to be connected a WPA-protected WI-FI network in order to receive the data content 106. The data delivery management system 110 can instruct the destination device 108 to connect to such a network.

A data delivery option may alternatively or additionally identify a price associated with delivery of the data content 106 to the destination device 108. In this respect, multiple data delivery options may be offered by the data delivery management system 110 based upon a delivery time or estimated delivery time. For example, a first data delivery option may provide delivery to the destination device 108 as soon as possible or in an otherwise best effort approach to delivering the data content 106 to the destination device 108, while a second data delivery option may provide delayed delivery to the destination device 108 at a discounted price. It is contemplated that delivery of the data content 106 to the destination device 108 after a specified time may be provided at no cost to a user of the source device 102. Accordingly, a user of the source device 102 can select a data delivery option for delivering the data content 106 to the destination device 108 at a price that is conducive to their budget.

A data delivery option may alternatively or additionally be based upon network performance data 112 obtained from a network performance analytics system 114. The network performance analytics system 114 can obtain network load data experienced by the data delivery network 104 and provide this data to the data delivery management system 110 as the network performance data 112, or a portion thereof. For example, the network performance analytics system 114 can obtain network load data experienced by one or more cells of a mobile telecommunications network included in the data delivery network 104. The data delivery management system 110 can utilize the network performance data 112 to ascertain congestion levels within the data delivery network 104 and consider the congestion levels in determining, for example, prices for one or more data delivery options for delivering the data content 106 to the destination device 108 when the source device 102 and/or the destination device 108 is located within an area of the data delivery network 104 that is experiencing, or is predicted to experience, a congestion level above a congestion threshold.

In some embodiments, the network performance data 112 includes historic network load data. Historic network load data is used herein to describe data obtained by the network performance analytics system 110 based upon network load experienced by the data delivery network 104 in the past or otherwise in non-real-time. In some other embodiments, the network performance data 112 includes current network load data. Current network load data is used herein to describe network load data that is obtained by the network performance analytics system 110 based upon a network load experienced by the data delivery network 104 in real-time or near real-time. Real-time, in this context, is the actual time during which a network load is experienced by the data delivery network 104, or a portion thereof. Near real-time, in this context, is the actual time during which a network load is experienced by the data delivery network 104 plus a delay on the order of microseconds or milliseconds, for example. What constitutes near-real time network load data versus historic network load data can be defined by the owner and/or operator of the network performance analytics system 114, the data delivery network 104, the owner and/or operator of the data delivery management system 110, and/or another entity. It should be understood that real-time network load data associated with a real-time network load of the data delivery network 104 and near real-time network load data associated with a near real-time network load of the data delivery network 104 might be received by the network performance analytics system 114 with delay caused by latency and/or other network phenomena. Moreover, this delay may increase with the additional time needed to provide the network performance data 112, including any network load data, to the data delivery management system 110. In some embodiments, the data delivery management system 110 includes the network performance analytics system 114, or vice versa, to mitigate this delay.

The network performance analytics system 114 is illustrated as being outside of the data delivery network 104. In some implementations, however, the network performance analytics system 114 is located within the data delivery network 104. In some embodiments, the network performance analytics system 114 is owned and/or operated by an owner or operator of the data delivery network 104. In some other embodiments, the network performance analytics system 114 is owned and/or operated by an owner or operator of the data delivery management system 110 or some other entity. Similarly, the data delivery management system 110 may be part of the data delivery network 104, and may be owned and/or operated by the owner or operator of the data delivery network 104 or another entity.

A data delivery option may alternatively or additionally be based upon policy data 116 obtained from a network policy system 118. The network policy system 118 can store one or more policies associated with the data delivery network 104. A policy may include or identify roaming agreements under which the source device 102 and/or the destination device 108 operate. A policy may include or identify user agreements such as subscription contracts or pre-paid with regard to accessing the data delivery network 104. For example, a policy may indicate a subscriber's data plan and the amount of data available for use in a given billing period. Other policies that may affect the delivery of the data content 106 from the source device 102 to the destination device 108 are contemplated.

The data delivery management system 110 can utilize the policy data 116 in determining one or more delivery options for delivering the data content 106 to the destination device 108 in accordance with a policy governing access by the source device 102 to the data delivery network 104. For example, the data delivery management system 110 can determine, based upon the policy data 116, that the source device 102 is associated with a data plan that does not have enough available data remaining to deliver the data content 106 to the destination device 108 but will have enough available data to deliver the data content 106 to the destination device 108 after a specified date on which the billing period and available data renews. In this example, the data delivery management system 110 can define a delivery option that specifies delivery of the data content 106 before the billing period renews will result in an additional charge. As another example, the data delivery management system can define a delivery option that specifies delivery of the data content 106 after the billing period renews will result in no additional charge.

The network policy system 118 is illustrated as being outside of the data delivery network 104. In some implementations, however, the network policy system 118 is located within the data delivery network 104. In some embodiments, the network policy system 118 is owned and/or operated by an owner or operator of the data delivery network 104. In some other embodiments, the network policy system 118 is owned and/or operated by an owner or operator of the data delivery management system 110 or some other entity.

A data delivery option may alternatively or additionally be based upon data received by the data delivery management system 110 from the source device 102 during a synchronization process (“synch”) 120. Data provided by the source device 102 to the data delivery management system 110 during the synch 120 may be, but is not limited to, location information, signal strength, battery level, and/or the like. The data delivery management system 110 can utilize the data from the synch 120 to determine one or more conditions for a data delivery option. For example, the source device 102 may provide, during the synch 120, a signal strength that is insufficient to initiate delivery of the data content 106 to the destination device 108 and, accordingly, the data delivery management system 1110 can define a data delivery option that is conditional based upon the source device 102 having a signal strength greater than or equal to a minimum signal strength specified in the data delivery option. It is contemplated that such a data delivery option can be selected by a user of the source 102 even if the source device 102 does not have a signal strength greater than or equal to a minimum signal strength, but delivery of the data content 106 can be prevented until the source device 102 does have a signal strength greater than or equal to a minimum signal strength.

The data delivery management system 110 can generate data delivery options based upon any combination of the aforementioned data. In some embodiments, the data delivery management system 110 dynamically provides one or more data delivery options to the source device 102 based upon the network performance data 112, the policy data 116, and/or data received during the synch 120. In this manner, the data delivery management system 110 can provide up-to-date delivery options to the destination device 108 for consideration by a user of the source device 102 in making a decision regarding how to deliver the data content 106 to the destination device 108. For example, the data delivery options can change on the source device 102 based upon conditions of the data delivery network 104 such that the user can determine at-a-glance if he or she would like to select a particular data delivery option to deliver the data content 106 to the destination device 108.

In some embodiments, the data delivery management system 110 provides the data delivery options via the synch 120. In some other embodiments, the data delivery management system 110 provides the data delivery options via short message service (“SMS”), email, or some other message service. In some other embodiments, the data delivery management system 110 pushes the data delivery options to the source device 102 over a data network, such as the data delivery network 104.

The data delivery management system 110 can receive a delivery record request 122 (“REQ” in FIG. 1) from the source device 102. In some embodiments, the delivery record request 122 includes a selection of a delivery option from the delivery options provided by the data delivery management system 110. The data delivery management system 110 can receive the delivery record request 122, parse the request to determine the selected delivery option, and instruct the data delivery network 104 to await the data content 106 and deliver the data content 106 to the destination device 108 in accordance with one or more delivery routes 124 determined by the data delivery management system 110 for the selected delivery option. In some embodiments, the data delivery management system 110 generates and associates the delivery route(s) 124 with the delivery options prior to sending the delivery options to the source device 102. In some other embodiments, the delivery management system 110 generates the delivery route(s) 124 after receiving the selected delivery option from the source device 102 in the delivery record request 122.

The data delivery management system 110 can generate and send a data delivery response 126 (“RESP” in FIG. 1) to the source device 102. The data delivery response 126, in some embodiments, includes an instruction to initiate delivery of the data content 106 to the destination device 102. In some other embodiments, the delivery record response 126 includes additional or alternative delivery options. For example, the selected delivery option may be out-of-date or otherwise unavailable, and so the data delivery management system 110 can generate an alternative delivery option and send the alternative delivery option to the source device 102 in the delivery record response 126. In some other embodiments, the delivery record response 126 includes additional information associated with a selected delivery option received by the data delivery management system 110 in the delivery record request 122. This additional information may include, for example, one or more pricing options associated with the selected delivery option. In this manner, each delivery option may have one or more pricing options that may change from time to time. By providing the pricing option(s) in the delivery record response 126, the pricing can be more closely tied to current network conditions or other factors that may affect the price of facilitating the delivery of the data content 106 via the data delivery network 104.

In some embodiments, the delivery record request 122 includes an input of user-defined data delivery specifications. For example, a user of the source device 102 may specify the data content 106, the destination device 108, and a requested deliver by date and/or time. The data delivery management system 110 can accept the user-defined data delivery specifications or generate and send an alternative delivery option to the source device in the delivery record response 126.

In some embodiments, the delivery record request 122 includes an input of a collect delivery option or a selection thereof. A collect delivery option allows the source device 102 to send the data content 106 to the destination device 108 collect, whereby payment for the delivery is handled by a user or other entity associated with the destination device 108.

Regardless of the delivery option utilized to deliver the data content 106 to the destination device 108, the destination device 108 may generate and send a delivery confirmation 128 to the data delivery management system 110, which, in turn, may send a delivery confirmation 130 to the source device 102 to notify a user of the source device 102 of successful delivery of the data content 106. The delivery confirmation 130 may be the delivery confirmation 128 forwarded by the data delivery management system 110 or a new delivery confirmation generated by the data delivery management system 110.

The illustrated source device 102 is configured to execute a source operating system 132, a source application program 134, a source web browser 136, and a data delivery application program 138. The source operating system 132 is a program for controlling the operation of the source device 102. According to various embodiments, the source operating system 132 may be SYMBIAN OS from SYMBIAN LIMITED, WINDOWS, WINDOWS CE, WINDOWS MOBILE, and/or WINDOWS PHONE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS and/or iOS families of operating systems from APPLE INC., the FREEBSD family of operating systems, the SOLARIS family of operating systems from ORACLE CORPORATION, other operating systems such as proprietary operating systems, and the like. Although a single source operating system 132 is shown, multiple operating systems are contemplated. Other operating systems are also contemplated.

The source application program 134 executes on top of the source operating system 132. The source application program 134 can be any application program that is capable of sending the data content 106 to the data delivery network 104. The source application program 134 may be, for example, a messaging application, an email application, a music application, a video application, a camera application, a game application, a productivity application, an entertainment application, an enterprise application, and/or the like. The source application program 134 includes a source data delivery module 140 that is configured to interact with the data delivery management system 110 on behalf of the source application program 134 so as to receive data delivery options, generate and send the delivery record request 122 to the data delivery management system 110, receive the delivery record response 126 from the data delivery management system 110, and/or receive the delivery confirmation 130 from the data delivery management system 110. The source application program 134 may also facilitate interaction with the data delivery management system 110 and/or the destination device 108 in other regards.

The source web browser 136 executes on top of the source operating system 132. The source web browser 136 is an application program through which a user of the source device 102 can access resources on the Web via the data delivery network 104 and the Internet (not shown). The source web browser 136 allows the source device 102 to access one or more uniform resource locators (“URLs”) associated with a Web page, Web site, and/or Web application to interact with the data delivery management system 110 so as to receive data delivery options, generate and send the delivery record request 122 to the data delivery management system 110, receive the delivery record response 126 from the data delivery management system 110, and/or receive the delivery confirmation 130 from the data delivery management system 110. The source web browser 136 may also facilitate interaction with the data delivery management system 110 and/or the destination device 108 in other regards.

The data delivery application program 138 executes on top of the source operating system 132. The data delivery application program 138 is a standalone application program configured to interact with the data delivery management system 110 so as to receive data delivery options, generate and send the delivery record request 122 to the data delivery management system 110, receive the delivery record response 126 from the data delivery management system 110, and/or receive the delivery confirmation 130 from the data delivery management system 110. The data delivery application program 138 may also facilitate interaction with the data delivery management system 110 and/or the destination device 108 in other regards.

Although the illustrated source device 102 includes the source application program 134, the source web browser 136, and the data delivery application program 138, the source device 102 may include one of these application programs or some combination thereof, but not all of these application programs. Accordingly, the illustrated example should not be interpreted as being limiting in any way.

In some embodiments, the source operating system 132, the source application program 134, the source data delivery module 140, the source web browser 136, and/or the data delivery application program 138 includes a connection manager. In some other embodiments, the source operating system 132, the source application program 134, the source data delivery module 140, the source web browser 136, and/or the data delivery application program 138 is in communication with a connection manager that can be stored in a memory of the source device 102 or otherwise accessible by the source device 102. The connection manager can be configured to manage all or a portion of the network connections available to the source device 102 a given time, including, for example, connections established via one or more WI-FI radios and/or one or more cellular radios of the source device 102. In some embodiments, the source operating system 132, the source application program 134, the source data delivery module 140, the source web browser 136, and/or the data delivery application program 138 notifies the connection manager that a connection is needed to communicate with the data delivery network 104 in accordance with a selected data delivery option, and in response, the connection manager determines and selects a connection in accordance with the selected data delivery option.

The illustrated destination device 108 is configured to execute a destination operating system 142, a destination application program 144, a destination web browser 146, and a data receipt application program 148. The destination operating system 142 is a program for controlling the operation of the destination device 108. According to various embodiments, the destination operating system 142 may be SYMBIAN OS from SYMBIAN LIMITED, WINDOWS, WINDOWS CE, WINDOWS MOBILE, and/or WINDOWS PHONE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS and/or iOS families of operating systems from APPLE INC., the FREEBSD family of operating systems, the SOLARIS family of operating systems from ORACLE CORPORATION, other operating systems such as proprietary operating systems, and the like. Although a single destination operating system 142 is shown, multiple operating systems are contemplated. Other operating systems are also contemplated.

The destination application program 144 executes on top of the destination operating system 142. The destination application program 144 can be any application program that is capable of receiving the data content 106 from the data delivery network 104. The destination application program 144 may be, for example, a messaging application, an email application, a music application, a video application, a camera application, a game application, a productivity application, an entertainment application, an enterprise application, and/or the like. The destination application program 144 includes a destination data delivery module 150 that is configured to enable receipt of the data content 106 and to interact with the data delivery management system 110 on behalf of the destination application program 144 to provide the delivery confirmation 128, where applicable, to the data delivery management system 110. The destination data delivery module 150 may also facilitate interaction with the data delivery management system 110 and/or the source device 102 in other regards.

The destination web browser 146 executes on top of the destination operating system 142. The destination web browser 146 is an application program through which a user of the destination device 108 can access resources on the Web via the data delivery network 104 and the Internet (not shown). The destination web browser 146 allows the destination device 108 to access one or more URLs associated with a Web page, Web site, and/or Web application to interact with the data delivery management system 110 to provide the delivery confirmation 128 to the data delivery management system 110 and to facilitate receipt of the data content 106 from the data delivery network 104. The destination web browser 146 may also facilitate interaction with the data delivery management system 110 and/or the source device 102 in other regards.

The data receipt application program 148 executes on top of the destination operating system 142. The data receipt application program 148 is a standalone application program configured to interact with the data delivery management system 110 to provide the delivery confirmation 128 to the data delivery management system 110 and to facilitate receipt of the data content 106 from the data delivery network 104. The data receipt application program 148 and/or the source device 102 may also facilitate interaction with the data delivery management system 110 in other regards.

Although the illustrated destination device 108 includes the destination application program 144, the destination web browser 146, and the data receipt application program 148, the destination device 108 may include one of these application programs or some combination thereof, but not all of these application programs. Accordingly, the illustrated example should not be interpreted as being limiting in any way.

It should be understood that some implementations of the operating environment 100 include multiple source devices 102, multiple data delivery networks 104, multiple destination devices 108, multiple data delivery management systems 110, multiple network performance analytics systems 114, and/or multiple network policy systems 118. Thus, the illustrated embodiment should be understood as being illustrative, and should not be construed as being limiting in any way.

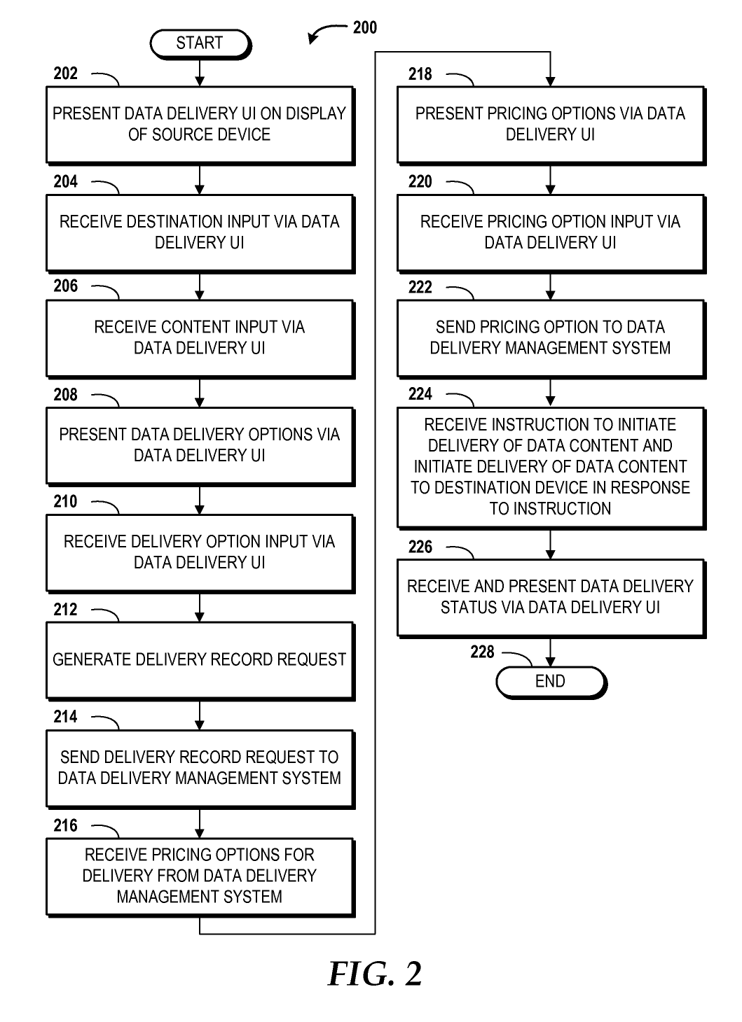

Turning now to FIG. 2, a flow diagram illustrating aspects of a method 200 for providing a data delivery user interface (“UI”) on a device, such as the source device 102, will be described, according to an illustrative embodiment. It should be understood that the operations of the illustrative methods disclosed herein are not necessarily presented in any particular order and that performance of some or all of the operations in an alternative order(s) is possible and is contemplated. The operations have been presented in the demonstrated order for ease of description and illustration. Operations may be combined, separated, added, omitted, modified, and/or performed simultaneously or in another order without departing from the scope of the subject disclosure.

It also should be understood that the illustrated methods can be ended at any time and need not be performed in their entirety. Some or all operations of the methods, and/or substantially equivalent operations, can be performed by execution of computer-executable instructions included on a computer-readable storage media, as defined below. The term “computer-executable instructions,” and variants thereof, as used in the description and claims, is used expansively herein to include routines, application programs, software, application modules, program modules, components, data structures, algorithms, and the like. Computer-executable instructions can be implemented on various system configurations, including single-processor or multiprocessor systems, distributed computing systems, minicomputers, mainframe computers, personal computers, hand-held computing devices, microprocessor-based, programmable consumer electronics, combinations thereof, and the like.

Thus, it should be appreciated that the logical operations described herein may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. As used herein, “cause a processor to perform operations” includes causing a processor of a computing system or device, such as, where applicable, the source device 102, the destination device 108, the data delivery management system 110, the network performance analytics system 114, or the network policy system 118, to perform one or more operations of the operations and/or causing the processor to direct other components of the computing system or device to perform one or more of the operations.

The method 200 is described as being performed by the source device 102 (shown in FIG. 1) executing the source data delivery module 140 within the source application program 134, the source web browser 136, and/or the data delivery application program 138, in part, to provide a data delivery UI through which a user can select a data delivery option for delivery of the data content 106 to the destination device 108. The method 200 begins and proceeds to operation 202, wherein the source device 102 presents a data delivery UI on a display of the source device 102.

From operation 202, the method 200 proceeds to operation 204, wherein the source device 102 receives a destination input via the data delivery UI. The destination input includes a selection of or other specification of a telephone number, an email address, a session initiation protocol (“SIP”) address, a URL, or other information capable of identifying the destination device 108. From operation 204, the method 200 proceeds to operation 206, wherein the source device 102 receives a content input via the data delivery UI. The content input includes a selection or other specification of the data content 106 that the user of the source device 102 intends to send to the destination device 108.

From operation 206, the method 200 proceeds to operation 208, wherein the source device 102 presents one or more delivery options via the data delivery UI. The source device 102 then receives a delivery option input via the data delivery UI at operation 210. The delivery option input includes a selection of or other specification of a delivery option from the delivery options presented at operation 208.

From operation 210, the method 200 proceeds to operation 212, wherein the source device 102 generates the delivery record request 122. In the illustrated embodiment, the delivery record request 122 includes the delivery option selected or otherwise specified in the delivery option input received at operation 210. At operation 214, the source device 102 sends the delivery record request 122 to the data delivery management system 110. From operation 214, the method 200 proceeds to operation 216, wherein the source device 102 receives one or more pricing options for the delivery option from the data delivery management system 110. The source device 102, at operation 218, presents the pricing option(s) via the data delivery UI. From operation 218, the method 200 proceeds to operation 220, wherein the source device 102 receives a pricing option input via the data delivery UI. The pricing option input includes a selection of or other specification of a pricing option from the pricing option(s) presented at operation 218. From operation 220, the method 200 proceeds to operation 222, wherein the source device 102 sends the selected pricing option to the data delivery management system 222.

In the illustrated embodiment, the data delivery management system 110 provides one or more pricing options to the source device 102 after one or more delivery options are provided. In some other embodiments, the data delivery management system 110 provides one or more pricing options, if any, with the delivery options.

From operation 222, the method 200 proceeds to operation 224, wherein the source device 102 receives an instruction from the data delivery management system 110 to initiate delivery of the data content 106 to the destination device 108. Also at operation 224, the source device 102 initiates delivery of the data content 106 to the destination device 108. The source device 102 may initiate delivery of the data content 106 to the destination device 108 by sending the data content 106 to the data delivery network 106.

From operation 224, the method 200 proceeds to operation 226, wherein the source device 102 receives and presents a data delivery status via the data delivery UI. The delivery status can include the delivery confirmation 130 confirming successful delivery of the data content 106 to the destination device 108, or a delivery failure notification (not shown) indicating unsuccessful delivery of the data content 106 to the destination device 108. It is contemplated that the status may additionally or alternatively include a note from a user of the destination device 108, for example, thanking a user of the source device 102 for sending the data content 106. From operation 226, the method 200 proceeds to operation 228, wherein the method 200 may end.

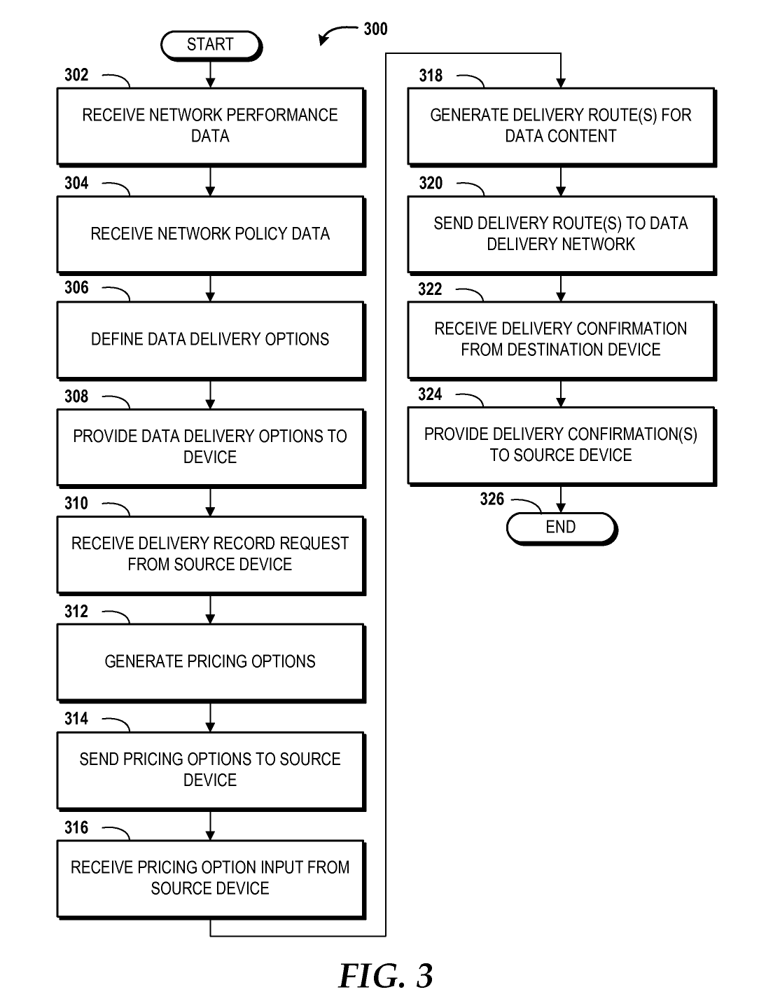

Turning now to FIG. 3, a flow diagram illustrating aspects of a method 300 for providing data delivery options to a device, such as the source device 102, will be described, according to an illustrative embodiment. The method 300 is described as being performed by the data delivery management system 110 (shown in FIG. 1). The method 300 begins and proceeds to operation 302, wherein the data delivery management system 110 receives the network performance data 112 from the network performance analytics system 114. From operation 302, the method 300 proceeds to operation 304, wherein the data delivery management system 110 receives the policy data 116 from the network policy system 118.

From operation 304, the method 300 proceeds to operation 306, wherein the data delivery management system 110 defines one or more data delivery options based upon the network performance data 112 and/or the network policy data 116. In some embodiments, the data delivery management system 110 defines the data delivery option(s) alternatively or additionally based upon data received from the source device 102 via the synch 120. In any case, at operation 308, the data delivery management system 110 provides the data delivery option(s) to the source device 102.

From operation 308, the method 300 proceeds to operation 310, wherein the data delivery management system 110 receives the delivery record request 122 from the source device 102. In the illustrated embodiment, the delivery record request 122 includes a delivery option selected or otherwise specified by a user of the source device 102. From operation 310, the method 300 proceeds to operation 312, wherein the data delivery management system 110 generates one or more pricing options for the delivery option received in the delivery record request 122. From operation 312, the method 300 proceeds to operation 314, wherein the data delivery management system 110 sends the pricing option(s) to the source device 102.

From operation 314 the method 300 proceeds to operation 316, wherein the data delivery management system 110 receives a pricing option input from the source device 102. The pricing option input includes a selection of or other specification of a pricing option from the pricing option(s) sent to the source device 102 at operation 314. From operation 316, the method 300 proceeds to operation 318, wherein the data delivery management system 110 generates the delivery routes(s) 124 for the data content 106. In the illustrated embodiment, the delivery route(s) 124 are generated after the data delivery management system 110 receives the pricing option input from the source device 102. In some other embodiments, the delivery route(s) 124 are generated at operation 306 when the data delivery options are defined. In any case, the data delivery management system 110, at operation 320, sends the delivery route(s) 124 to the data delivery network 104 to instruct the data delivery network 104 how to route the data content 106 to the destination device 108.

From operation 320, the method 300 proceeds to operation 322, wherein the data delivery management system 110 receives the delivery confirmation 128 from the destination device 108. In some other embodiments, the data delivery management system 110 receives a data delivery status from the data delivery network 104 indicating unsuccessful delivery of the data content 106 to the destination device 108. From operation 322, the method 300 proceeds to operation 324, wherein the data delivery management system 110 provides the delivery confirmation 128 to the source device 102, for example, as the delivery confirmation 130. From operation 324, the method 300 proceeds to operation 326, wherein the method 300 may end.

In the illustrated embodiment, the pricing options are provided after the delivery options. In some other embodiments, the pricing options, if any, are defined with the delivery options at operation 306 and provided to the source device 102 at operation 308.

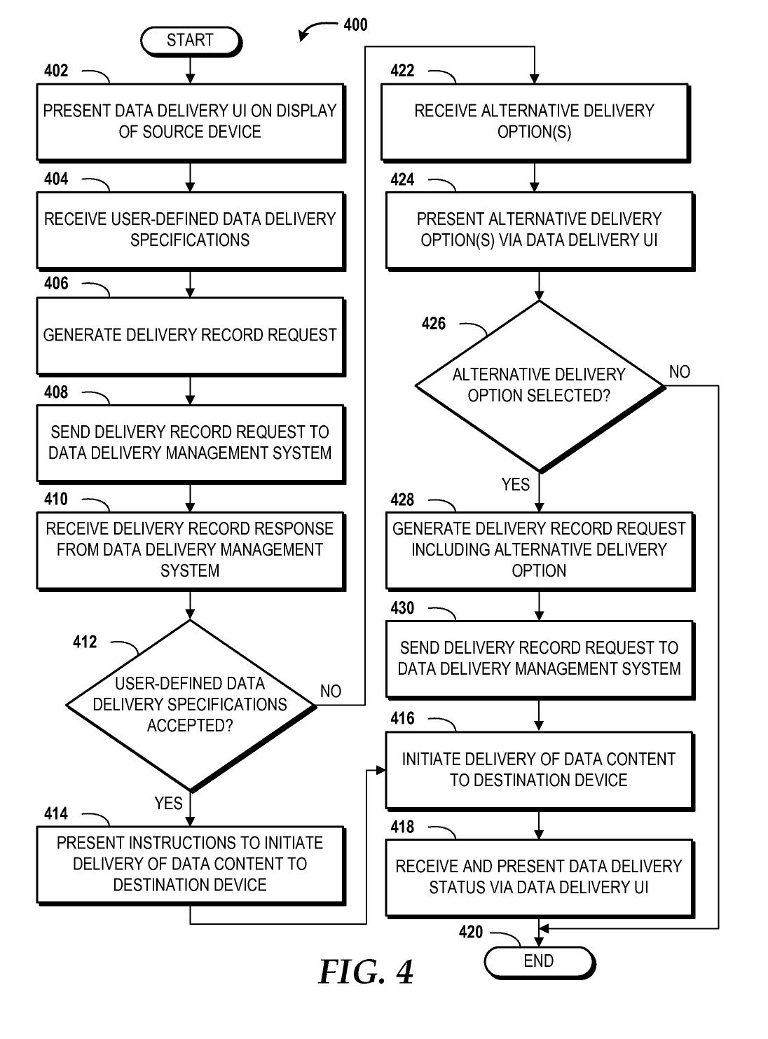

Turning now to FIG. 4, a flow diagram illustrating aspects of a method 400 for providing a data delivery UI on a device, such as the source device 102, will be described, according to an illustrative embodiment. The method 400 is described as being performed by the source device 102 (shown in FIG. 1) executing the source data delivery module 140 within the source application program 134, the source web browser 136, and/or the data delivery application program 138, in part, to provide a data delivery UI. The method 400 begins and proceeds to operation 402, wherein the source device 102 presents a data delivery UI on a display of the source device 102.

From operation 402, the method 400 proceeds to operation 404, wherein the source device 102 receives user-defined data delivery specifications. The user-defined data delivery specification can include, but are not limited to, an identification of the data content 106 to be delivered, the destination device 108 and/or other destination devices to which the data content 106 is to be delivered, the desired time(s) at which or by which the data content 106 is to be delivered, and/or the price(s) associated with the delivery of the data content 106. It should be understood that the aforementioned user-defined data delivery specifications are merely provided as examples and should not be interpreted as being limiting in any way.

From operation 404, the method 400 proceeds to operation 406, wherein the source device 102 generates the delivery record request 122. In the illustrated embodiment, the delivery record request 122 includes the user-defined data delivery specifications received at operation 404. At operation 408, the source device 102 sends the delivery record request 122 to the data delivery management system 110. From operation 408, the method 400 proceeds to operation 410, wherein the source device 102 receives the delivery record response 126 from the data delivery management system 110. In the illustrated embodiment, the delivery record response 126 includes an indication of whether the user-defined data delivery specifications are accepted by the data delivery management system 110.

From operation 410, the method 400 proceeds to operation 412, wherein the source device 102 determines if the user-defined data delivery specifications have been accepted by the data delivery management system 110 based upon the indication included in the delivery record response 126. If the delivery record response 126 includes an indication that the user-defined data delivery specifications have been accepted by the data delivery management system 110, the source device 102 determines, at operation 412, that the user-defined data delivery specification have been accepted, and the method 400 proceeds to operation 414. At operation 414, the source device 102 presents instructions to initiate delivery of the data content 106 to the destination device 108. These instructions may be included in the delivery record response 126. Alternatively, these instructions may be generated by the source device 102 in response to receipt of the delivery record response 126 including an indication that the user-defined data delivery specifications have been accepted by the data delivery management system 110.

From operation 414, the method 400 proceeds to operation 416, wherein the source device 102 initiates delivery of the data content 106 to the destination device 108. The source device 102, at operation 418, receives and presents a data delivery status via the data delivery UI. The delivery status can include the delivery confirmation 130 confirming successful delivery of the data content 106 to the destination device 108, or a delivery failure notification (not shown) indicating unsuccessful delivery of the data content 106 to the destination device 108. It is contemplated that the status may additionally or alternatively include a note from a user of the destination device 108. From operation 418, the method 400 proceeds to operation 420, wherein the method 400 may end.

If the delivery record response 126 includes an indication that the user-defined data delivery specifications have not been accepted by the data delivery management system 110, the source device 102 determines, at operation 412, that the user-defined data delivery specification have not been accepted, and the method 400 proceeds to operation 422. At operation 422, the source device 102 receives one or more alternative delivery options provided by the delivery management system 110. The alternative delivery option(s) may be included in the data delivery response 126 and, in this regard, also be the indication that the user-defined data delivery specifications have not been accepted. From operation 422, the data delivery management system 110 presents the alternative delivery option(s) via the data delivery UI.

From operation 424, the method 400 proceeds to operation 426, wherein the source device 102 determines if an alternative delivery option is selected. If an alternative delivery option is not selected, the method 400 proceeds to operation 420, wherein the method 400 may end. If an alternative delivery option is selected, the method 400 proceeds to operation 428, wherein the source device 102 generates a second delivery record request including the selected alternative delivery option. From operation 428, the method 400 proceeds to operation 430, wherein the source device 102 sends the second delivery record request to the data delivery management system 110.

From operation 430, the method 400 proceeds to operation 416, wherein the source device 102 initiates delivery of the data content 106 to the destination device 108. The source device 102 may receive an instruction to initiate delivery in a second delivery record response. The source device 102, at operation 418, receives and presents a data delivery status via the data delivery UI. The delivery status can include the delivery confirmation 130 confirming successful delivery of the data content 106 to the destination device 108, or a delivery failure notification (not shown) indicating unsuccessful delivery of the data content 106 to the destination device 108. It is contemplated that the status may additionally or alternatively include a note from a user of the destination device 108. From operation 418, the method 400 proceeds to operation 420, wherein the method 400 may end.

In the illustrated embodiment, pricing options are not provided. In some other embodiments, the data delivery management system 110 provides pricing options in the delivery record response 126 and/or with the alternative delivery options.

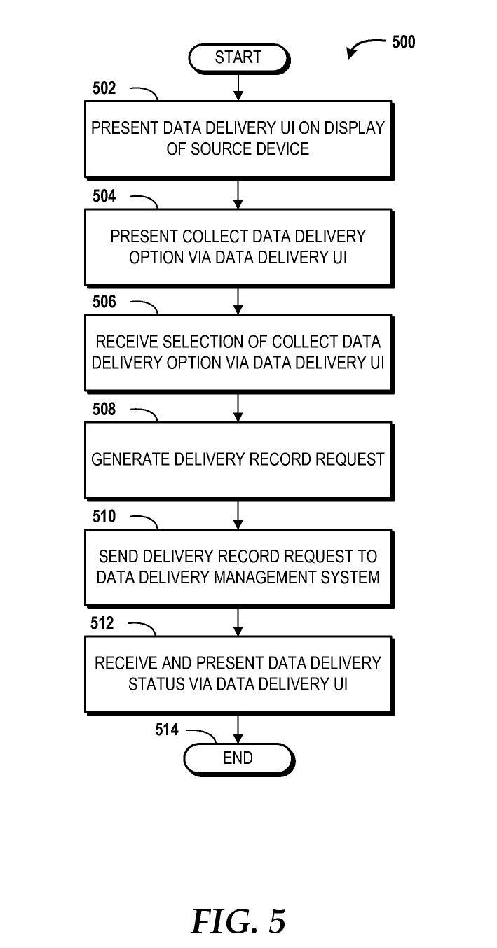

Turning now to FIG. 5, a flow diagram illustrating aspects of a method 500 for providing a collect data delivery option via a data delivery UI will be described, according to an illustrative embodiment. The method 500 is described as being performed by the source device 102 (shown in FIG. 1) executing the source data delivery module 140 within the source application program 134, the source web browser 136, and/or the data delivery application program 138, in part, to provide a data delivery UI. The method 500 begins and proceeds to operation 502, wherein the source device 102 presents a data delivery UI on a display of the source device 102.

From operation 502, the method 500 proceeds to operation 504, wherein the source device 102 presents a collect data delivery option via the data delivery UI. The collect data delivery option may be presented alone or with other data delivery options. From operation 504, the method 500 proceeds to operation 506, wherein the source device 102 receives a selection or other specification of the collect data option via the data delivery UI.

From operation 506, the method 500 proceeds to operation 508, wherein the source device 102 generates the delivery record request 122. In the illustrated embodiment, the delivery record request 122 includes the collected data delivery option selected at operation 506. From operation 508, the method 500 proceeds to operation 510, wherein the source device 102 sends the delivery record request 122 to the data delivery management system 110. In response, the source device 102, at operation 512, receives and presents a data delivery status via the data delivery UI. The delivery status can include the delivery confirmation 130 confirming successful delivery of the data content 106 to the destination device 108, or a delivery failure notification indicating unsuccessful delivery of the data content 106 to the destination device 108, such as if a user of the destination device 108 denies the attempt to deliver the data content 106 collect. It is contemplated that the status may additionally or alternatively include a note from a user of the destination device 108. From operation 512, the method 500 proceeds to operation 514, wherein the method 500 may end.

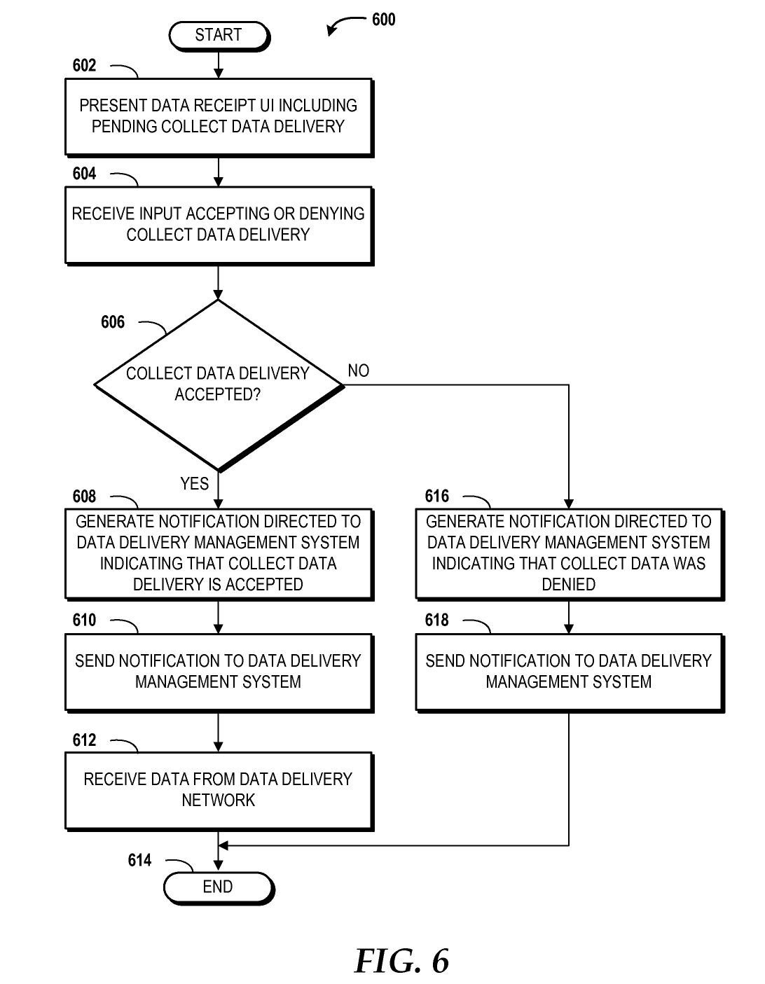

Turning now to FIG. 6, a flow diagram illustrating aspects of a method 600 for providing a data receipt UI on a device, such as the destination device 108, will be described, according to an illustrative embodiment. The method 600 is described as being performed by the destination device 108 (shown in FIG. 1) executing the destination data delivery module 150 within the destination application program 144, the destination web browser 146, and/or the data receipt application program 148, in part, to provide a data receipt UI. The method 600 begins and proceeds to operation 602, wherein the destination device 108 presents a data receipt UI on a display of the destination device 108. In the illustrated embodiment, the data receipt UI includes an indication of a pending collect data delivery, for example, initiated by the source device 102. The indication may be a notification such as a visual and/or audible notification to make the user of the destination device 108 aware of a pending collect data delivery.

From operation 602, the method 600 proceeds to operation 604, wherein the destination device 108 receives an input accepting or denying a collect delivery of the data content 106. From operation 604, the method 600 proceeds to operation 606, wherein the destination device 108 determines if collect delivery of the data content 106 is accepted based upon the input received at operation 604. If, at operation 606, the destination device 108 determines that collect delivery of the data content 106 is accepted, the method 600 proceeds to operation 608, wherein the destination device 108 generates a notification directed to the data delivery management system 110 indicating that collect data delivery of the data content 106 is accepted by the destination device 108. From operation 608, the method 600 proceeds to operation 610, wherein the destination device 108 sends the notification to the data delivery management system 110. From operation 612, the destination device 108 receives the data content 106 from the data delivery network 104. The method 600 then proceeds to operation 614, wherein the method 600 may end.

If, at operation 606, the destination device 108 determines that collect delivery of the data content 106 is not accepted, the method 600 proceeds to operation 616, wherein the destination device 108 generates a notification directed to the data delivery management system 110 indicating that collect data delivery of the data content 106 is not accepted by the destination device 108. From operation 616, the method 600 proceeds to operation 618, wherein the destination device 108 sends the notification to the data delivery management system 110. The method 600 then proceeds to operation 614, wherein the method 600 may end.

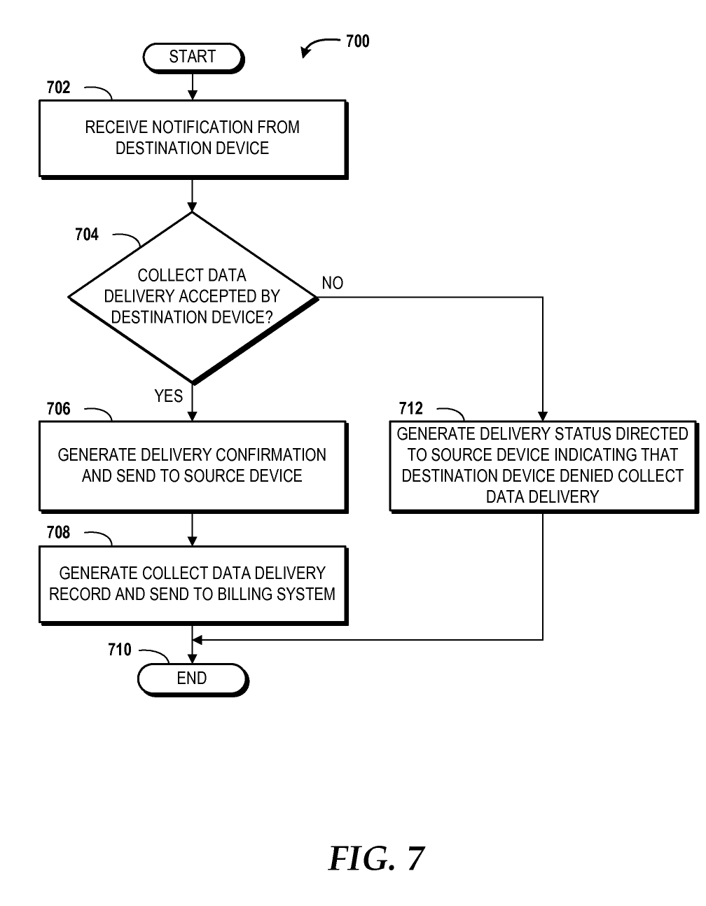

Turning now to FIG. 7, a flow diagram illustrating aspects of a method 700 for handling collect data delivery notifications will be described, according to an illustrative embodiment. The method 700 is described as being performed by the data delivery management system 110. The method 700 begins and proceeds to operation 702, wherein the data delivery management system 110 receives a notification from the destination device 108. From operation 702, the method 700 proceeds to operation 704, wherein the data delivery management system 110 determines, based upon the notification, whether collect data delivery of the data content 106 has been accepted by the destination device 108. If the data delivery management system 110 determines that collect data delivery of the data content 106 has been accepted by the destination device 108, the method 700 proceeds to operation 706, wherein the data delivery management system 110 generates the delivery confirmation 130 and sends the delivery confirmation 130 to the source device 102.

From operation 706, the method 700 proceeds to operation 708, wherein the data delivery management system 110 generates a collect data delivery record and sends the collect data delivery record to a billing system (not shown). The collect data delivery record instructs the billing system to bill a user or other entity associated with the destination device 108 for the delivery of the data content 106. From operation 708, the method 700 proceeds to operation 710, wherein the method 700 may end.

If the data delivery management system 110 determines that collect data delivery of the data content 106 has not been accepted by the destination device 108, the method 700 proceeds to operation 712, wherein the data delivery management system 110 generates a delivery status directed to the source device 102 indicating that collect delivery of the data content 106 to the destination device 108 has been denied. The data delivery management system 110 may provide this status to the source device 102 via the delivery confirmation 130. The method 700 then proceeds to operation 710, wherein the method 700 may end.

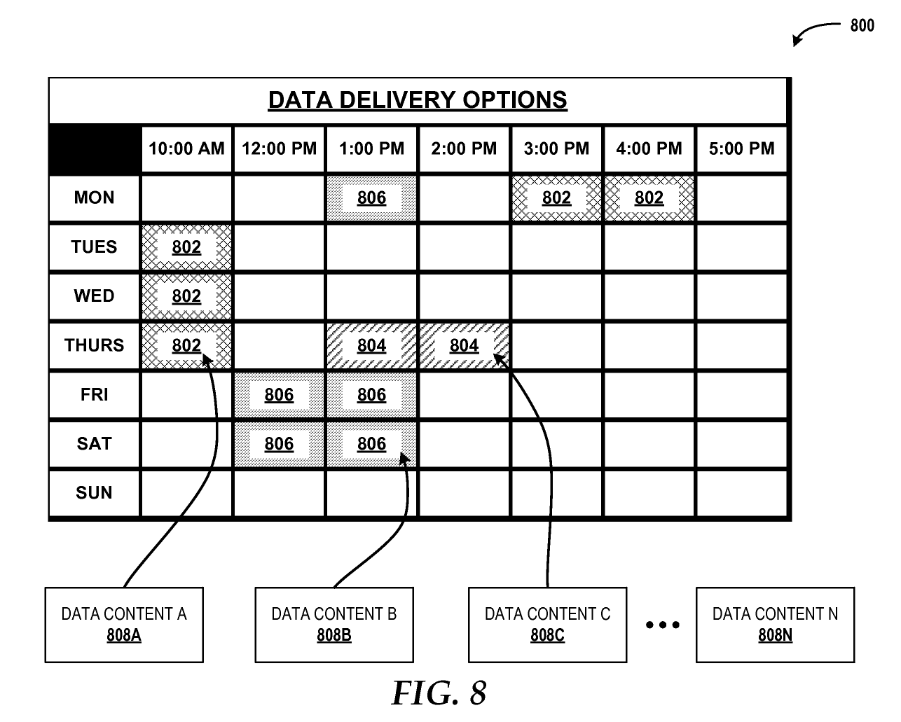

Turning now to FIG. 8, a user interface diagram illustrating aspects of a data delivery UI 800 will be described, according to an illustrative embodiment. In the illustrated example, the data delivery UI 800 provides a visualization of a plurality of data delivery options at various times throughout a given week. In particular, the data delivery UI 800 is populated with a first set of delivery options 802, a second set of delivery options 804, and a third set of delivery options 806. Each set of delivery options may be associated with a particular color or other visual characteristic to visually distinguish between various price levels associated with the delivery of data content to one or more destination devices if selected. In this manner, a user can quickly view the data delivery UI 800 to determine if a delivery option conducive to their budget is available and assign data content to that delivery option.

The data delivery UI 800 also includes a plurality of data contents 808A-808N. A user can select data content from the plurality of data contents 808A-808N and assign the selected data content to an available data option by dragging and dropping the selected data content or via some other input mechanism, such as, but not limited to, touch or voice input. In the illustrated example, the data content A 808A is assigned to a delivery option included in the first set of delivery options 802, the data content B 808B is assigned to a delivery option included in the second set of delivery options 804, and the data content C 808C is assigned to a delivery option included in the third set of delivery options 806.

In some embodiments, the visual characteristic used to visually distinguish between various price levels is set by a user. For example, a user can assign a green color to data delivery options that are below a first price threshold, a yellow color to data delivery options that are below a second price threshold, and a red color to data delivery options that are below a third price threshold, and so on, wherein the various price thresholds are set by the user. In some other embodiments, the visual characteristic used to visually distinguish between various price levels is set by the data delivery management system 110 or by another system or entity.

It should be understood that the data delivery UI 800 is merely one example of how a data delivery UI might be presented to a user. The data delivery UI 800 is intended to simplify the selection of data delivery options for a user by relying on visual characteristics to distinguish among various data delivery options. It is contemplated, however, that a data delivery UI may provide more or less control to a user to facilitate the selection or other specification of data delivery options, including facilitating user-defined specifications as described herein above with reference to FIG. 4. It is also contemplated that a data delivery UI may be integrated within an existing application such as the source application program 134 as part of the source data delivery module 140 illustrated and described with reference to FIG. 1, provided in a standalone application such as the data delivery application program 138, and/or provided in a Web page, Web site, or Web application accessible via the source web browser 136. Accordingly, it should be appreciated that the data delivery UI 800 and other data delivery UI examples and descriptions provided herein are not exhaustive and that numerous additional and/or alternative data delivery UIs are not mentioned herein for the sake of brevity. As such, the above embodiments are illustrative, and should not be construed as being limiting in any way.

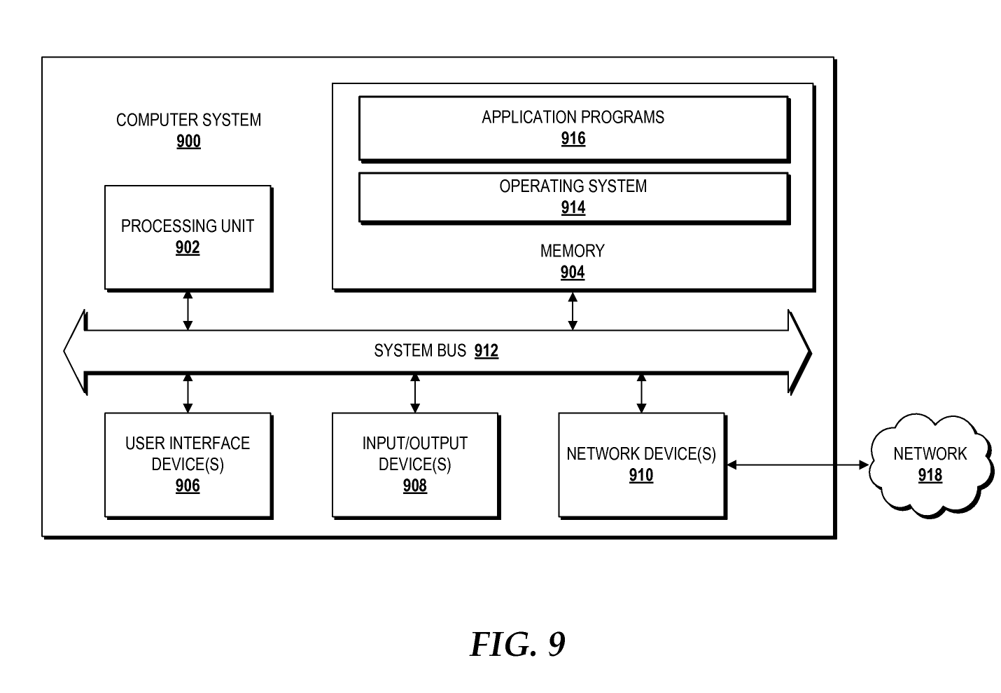

FIG. 9 is a block diagram illustrating a computer system 900 configured to perform various operations disclosed herein. The computer system 900 includes a processing unit 902, a memory 904, one or more user interface devices 906, one or more input/output (“I/O”) devices 908, and one or more network devices 910, each of which is operatively connected to a system bus 912. The bus 912 enables bi-directional communication between the processing unit 902, the memory 904, the user interface devices 906, the I/O devices 908, and the network devices 910. In some embodiments, the source device 102, the destination device 108, the data delivery management system 110, the network performance analytics system 114, and/or the network policy system 118 are configured like the computer system 900. It should be understood, however, that the source device 102, the destination device 108, the data delivery management system 110, the network performance analytics system 114, and/or the network policy system 118 may include additional functionality or include less functionality than now described.

The processing unit 902 may be a standard central processor that performs arithmetic and logical operations, a more specific purpose programmable logic controller (“PLC”), a programmable gate array, or other type of processor known to those skilled in the art and suitable for controlling the operation of the computer system 900. Processing units are generally known, and therefore are not described in further detail herein.

The memory 904 communicates with the processing unit 902 via the system bus 912. In some embodiments, the memory 904 is operatively connected to a memory controller (not shown) that enables communication with the processing unit 902 via the system bus 912. The illustrated memory 904 includes an operating system 914 and one or more application programs 916.

The operating system 914 can include, but is not limited to, members of the WINDOWS, WINDOWS CE, WINDOWS MOBILE, and/or WINDOWS PHONE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS and/or iOS families of operating systems from APPLE INC., the FREEBSD family of operating systems, the SOLARIS family of operating systems from ORACLE CORPORATION, other operating systems such as proprietary operating systems, and the like. The operating system 914 may include the source operating system 132 or the destination operating system 142 if the source device 102 or the destination device 108, respectively, utilize the architecture of the computer system 900.

The application programs 916 can include computer-executable instructions that, when executed by the processing unit 902, cause the computer system 900 to perform operations such as those described herein above with reference to methods set forth in FIGS. 2-7. The application programs 916 may include the source application program 134 including the source data delivery module 140, the source web browser 136, the data delivery application program 138, the destination application program 144 including the destination data delivery module 150, the destination web browser 146, the data receipt application program 148, one or more network performance analysis application programs, one or more data delivery management application programs, and/or one or more network policy application programs.

The user interface devices 906 may include one or more devices with which a user accesses the computer system 900. The user interface devices 906 may include, but are not limited to, computers, servers, personal digital assistants, telephones (e.g., cellular, IP, or landline), or any suitable computing devices. The I/O devices 908 enable a user to interface with the program modules. In one embodiment, the I/O devices 908 are operatively connected to an I/O controller (not shown) that enables communication with the processing unit 902 via the system bus 912. The I/O devices 908 may include one or more input devices, such as, but not limited to, a keyboard, a mouse, or an electronic stylus. Further, the I/O devices 908 may include one or more output devices, such as, but not limited to, a display screen or a printer.

The network devices 910 enable the computer system 900 to communicate with other networks or remote systems via a network 918, such as the data delivery network 104 illustrated and described with reference to FIG. 1 and/or other network(s). Examples of the network devices 910 include, but are not limited to, a modem, a radio frequency (“RF”) or infrared (“IR”) transceiver, a telephonic interface, a bridge, a router, or a network card. The network 918 may include a wireless network such as, but not limited to, a WLAN such as a WI-FI network, a WWAN, a wireless PAN (“WPAN”) such as BLUETOOTH, or a wireless MAN (“WMAN”). Alternatively, the network 918 may be a wired network such as, but not limited to, a WAN such as the Internet, a LAN such as the Ethernet, a wired PAN, or a wired MAN.

The network 918 embodied as a cellular network may utilize a mobile telecommunications technology such as, but not limited to, GSM, UMTS, CDMA ONE, CDMA2000, LTE, and various other 2G, 2.5G, 3G, 4G, and greater generation mobile telecommunications technologies. In addition, mobile data communications technologies such as GPRS, EDGE, the HSPA protocol family including HSDPA, EUL or otherwise termed HSUPA, HSPA+, and various other current and future mobile data communications technologies are contemplated for use by the network 918. Therefore, the embodiments presented herein should not be construed as being limiting to a particular mobile telecommunications technology and/or standards utilizing such technologies.

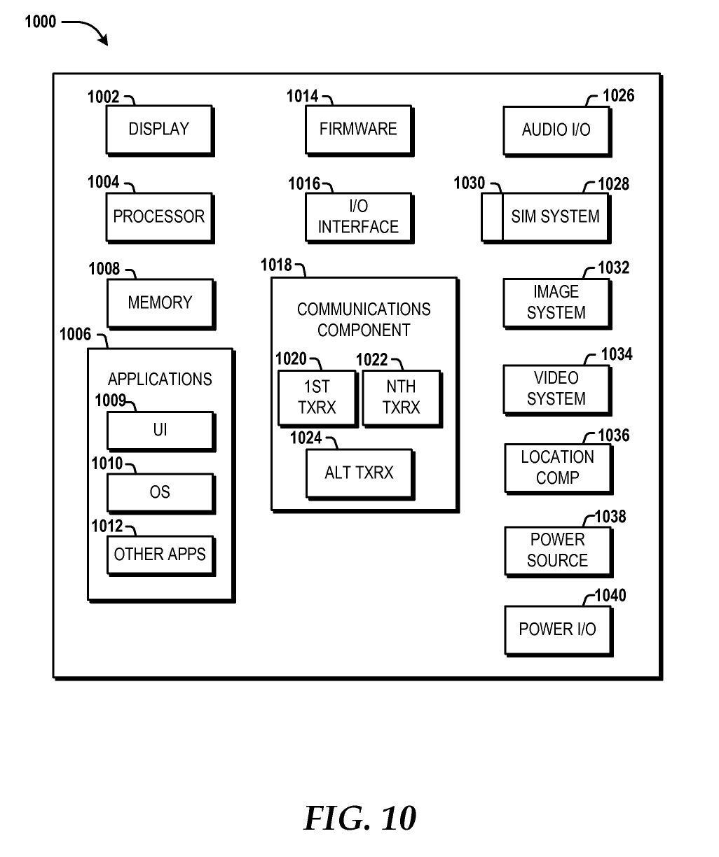

Turning now to FIG. 10, an illustrative mobile device 1000 and components thereof will be described. In some embodiments, the source device 102 and/or the destination device 108 are configured like the mobile device 1000. It should be understood, however, that the mobile device 102 may include additional functionality or include less functionality than now described. Although connections are not shown between the components illustrated in FIG. 10, the components can interact with each other to carry out device functions. In some embodiments, the components are arranged so as to communicate via one or more busses (not shown). It should be understood that FIG. 10 and the following description are intended to provide a general understanding of a suitable environment in which various aspects of embodiments can be implemented.

As illustrated in FIG. 10, the mobile device 1000 includes a display 1002 for displaying data including, but not limited to, graphical user interface (“GUI”) elements, text, images, video, virtual keypads and/or keyboards, messaging data, notification messages, metadata, internet content, device status, time, date, calendar data, device preferences, map and location data, combinations thereof, and/or the like. The mobile device 1000 also includes a processor 1004 for processing data and/or executing computer-executable instructions of one or more applications 1006, such as the stored in a memory 1008. In some embodiments, the applications 1006 include a UI application 1009. The UI application 1009 interfaces with an operating system (“OS”) application 1010, such as the source operating system 132 or the destination operating system 142, to facilitate user interaction with device functionality and data. In some embodiments, the OS application 1010 is one of SYMBIAN OS from SYMBIAN LIMITED, WINDOWS MOBILE OS from MICROSOFT CORPORATION, WINDOWS PHONE OS from MICROSOFT CORPORATION, PALM WEBOS from HEWLETT PACKARD CORPORATION, BLACKBERRY OS from RESEARCH IN MOTION LIMITED, IOS from APPLE INC., and ANDROID OS from GOOGLE INC. These operating systems are merely illustrative of the operating systems that may be used in accordance with the embodiments disclosed herein.

The UI application 1009 aids a user in selecting or otherwise specifying data delivery options, presenting delivery status(es), entering message content, viewing received messages, answering/initiating calls, entering/deleting data, entering and setting user IDs and passwords for device access, configuring settings, manipulating address book content and/or settings, multimode interaction, interacting with other applications 1012, and otherwise facilitating user interaction with the OS application 1010, and the other applications 1012.

In some embodiments, the other applications 1012 include, for example, the source application program 134 including the source data delivery module 140, the source web browser 136, the data delivery application program 138, the destination application program 144 including the destination data delivery module 150, the destination web browser 146, the data receipt application program 148, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 1006 or portions thereof are stored in the memory 1008 and/or in a firmware 1014, and are executed by the processor 1004. The firmware 1014 may also store code for execution during device power up and power down operations.

The mobile device 1000 also includes an input/output (“I/O”) interface 1016 for the input/output of data such as location information, presence status information, user IDs, passwords, and application initiation (start-up) requests. In some embodiments, the I/O interface 1016 is a hardwire connection such as a universal serial bus (“USB”), mini-USB, micro-USB, audio jack, PS2, IEEE 1394, serial, parallel, Ethernet (RJ45) port, RJ11 port, proprietary port, combinations thereof, or the like. In some embodiments, the mobile device 1000 is configured to synchronize with another device (e.g., a computer) to transfer content stored to/from the mobile device 1000. In some embodiments, the mobile device 1000 is configured to receive updates to one or more of the applications 1006 via the I/O interface 1016. In some embodiments, the I/O interface 1016 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1016 may be used for communications between the mobile device 1000 and a network device or local device instead of, or in addition to, a communications component 1018.

The communications component 1018 interfaces with the processor 1004 to facilitate wireless communications with one or more networks such as the data delivery network 104 illustrated in FIG. 1. In some embodiments, other networks include networks that utilize non-cellular wireless technologies such as WI-FI or WIMAX. In some embodiments, the communications component 1018 includes a multimode communications subsystem for facilitating communications via cellular networks and one or more other networks.

The communications component 1018, in some embodiments, includes one or more transceivers each configured to communicate over the same or a different wireless technology standard. For example, the transceivers of the communications component 1018 may be configured to communicate using GSM, CDMAONE, CDMA2000, LTE, and various other 2G, 2.5G, 3G, 4G, and greater generation technology standards. Moreover, the communications component 1018 may facilitate communications over various channel access methods (which may or may not be used by the aforementioned standards) including, but not limited to, TDMA, FDMA, W-CDMA, OFDM, SDMA, and the like. In addition, the communications component 1018 may facilitate data communications using GPRS, EDGE, the HSPA protocol family including HSDPA, EUL or otherwise termed HSUPA, HSPA+, and various other current and future wireless data access standards.

In the illustrated embodiment, the communications component 1018 includes a first cellular transceiver 1020 that operates in one mode (e.g., GSM), and an N^{th} cellular transceiver 1022 operates in a different mode (e.g., UMTS). While only two cellular transceivers 1020, 1022 are illustrated, it should be appreciated that more than two transceivers can be included in the communications component 1018.

The illustrated communications component 1018 also includes an alternative communications transceiver 1024 for use by other communications technologies including WI-FI, WIMAX, BLUETOOTH, infrared, infrared data association (“IRDA”), near field communications (“NFC”), other RF, combinations thereof, and the like. In some embodiments, the communications component 1018 also facilitates reception from terrestrial radio networks, digital satellite radio networks, internet-based radio service networks, combinations thereof, and the like.

The communications component 1018 processes data from a network such as an internet, an intranet, a home broadband network, a WI-FI hotspot, and the like, via an internet service provider (“ISP”), digital subscriber line (“DSL”) provider, or broadband provider.

Audio capabilities for the mobile device 1000 may be provided by an audio I/O component 1026 that includes a speaker for the output of audio signals and a microphone to collect audio signals.

The illustrated mobile device 1000 also includes a USIM system 1028 that includes a SIM slot interface 1030 for accommodating a USIM card. In some embodiments, the USIM system 1028 is configured to accept insertion of other SIM cards for access to other network types such as GSM. In other embodiments, the USIM system 1028 is configured to accept multiple SIM cards. In still other embodiments, the USIM system 1028 is configured to accept a universal integrated circuit card (“UICC”) with one or more SIM applications stored thereupon.

The illustrated mobile device 1000 also includes an image capture and processing system 1032 (“image system”). Photos may be obtained via an associated image capture subsystem of the image system 1032, for example, a camera. The mobile device 1000 may also include a video system 1034 for capturing, processing, recording, and/or modifying video content. Photos and videos obtained using the image system 1032 and the video system 1034, respectively, may be added as message content to an MMS message and sent to another mobile device.

The illustrated mobile device 1000 also includes a location component 1036 for sending and/or receiving signals such as global positioning system (“GPS”) data, assisted-GPS data, WI-FI/WIMAX and/or cellular network triangulation data, combinations thereof, and the like, for determining a location of the mobile device 1000. The location component 1036 may communicate with the communications component 1018 to retrieve triangulation data for determining a location of the mobile device 1000. In some embodiments, the location component 1036 interfaces with cellular network nodes, telephone lines, satellites, location transmitters and/or beacons, wireless network transmitters and receivers, combinations thereof, and the like. In some embodiments, the location component 1036 includes one or more sensors such as a compass, an accelerometer, and/or a gyroscope to determine the orientation of the mobile device 1000. Using the location component 1036, the mobile device 1000 can generate and/or receive data to identify its location, or transmit data used by other devices to determine the location of the mobile device 1000. The location component 1036 may include multiple components for determining the location and/or orientation of the mobile device 1000.

The illustrated mobile device 1000 also includes a power source 1038, such as one or more batteries and/or other power subsystem (AC or DC). The power source 1038 may interface with an external power system or charging equipment via a power I/O component 1040.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 1000 or other devices or computers described herein, such as the computer system 900 described above with reference to FIG. 9. For purposes of the claims, the phrase “computer-readable storage medium” and variations thereof, does not include waves, signals, and/or other transitory and/or intangible communication media, per se. In an illustrative embodiment, a computer-readable storage medium is a tangible computer-readable storage medium.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the mobile device 1000 in order to store and execute the software components presented herein. It is also contemplated that the mobile device 1000 may not include all of the components shown in FIG. 10, may include other components that are not explicitly shown in FIG. 10, or may utilize an architecture completely different than that shown in FIG. 10.

Based on the foregoing, it should be appreciated that concepts and technologies for customized data delivery have been disclosed herein. Although the subject matter presented herein has been described in language specific to computer structural features, methodological and transformative acts, specific computing machinery, and computer-readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the subject disclosure.

We claim:

1. A device comprising:
a display;
a processor in communication with the display; and
a memory in communication with the processor, the memory comprising instructions that, when executed by the processor, cause the processor to perform operations comprising
presenting a data delivery user interface on the display,
receiving, via the data delivery user interface, input associated with delivery of data content to a destination device,
generating a delivery record request comprising the input,
sending the delivery record request to a data delivery management system, and
receiving a delivery record response from the data delivery management system.

2. The device of claim 1, wherein the memory comprises further instructions that, when executed by the processor, cause the processor to perform further operations comprising presenting, via the data delivery user interface on the display, a plurality of delivery options for delivery of the data content to the destination device, and the input comprises a selection of a delivery option from the plurality of delivery options.

3. The device of claim 2, wherein each delivery option of the plurality of delivery options comprises a date and time at which the data content is to be delivered to the destination device.

4. The device of claim 3, wherein each delivery option of the plurality of delivery options further comprises a price associated with delivery of the data content to the destination device at the date and time.

5. The device of claim 4, wherein the delivery record response comprises an instruction to initiate delivery of the data content to the destination device, and the memory comprises further instructions that, when executed by the processor, cause the processor to perform further operations comprising sending the data content to a data delivery network to initiate delivery of the data content to the destination device.

6. The device of claim 3, wherein the delivery record response comprises a plurality of pricing options for the delivery option, and the memory comprises further instructions that, when executed by the processor, cause the processor to perform further operations comprising presenting, via the data delivery user interface on the display, the plurality of pricing options.

7. The device of claim 6, wherein the memory comprises further instructions that, when executed by the processor, cause the processor to perform further operations comprising:
receiving a selection of a pricing option from the plurality of pricing options;
sending the selection of the pricing option to the data delivery management system;
receiving a second delivery record response comprising an instruction to initiate delivery of the data content to the destination device; and
sending the data content to a data delivery network to initiate delivery of the data content to the destination device.

8. The device of claim 1, wherein the input comprises user-defined data delivery specifications, the delivery record response comprises an indication of whether the user-defined data delivery specifications are accepted by the data delivery management system, and the memory comprises further instructions that, when executed by the processor, cause the processor to perform further operations comprising:
if the user-defined data delivery specification are accepted by the data delivery management system,
presenting, via the data delivery user interface on the display, instructions to initiate delivery of the data content to the destination device, and
initiating delivery of the data content to the destination device; and
if the user-defined data delivery specifications are not accepted by the data delivery management system,
receiving an alternative delivery option from the data delivery management system,
presenting, via the data delivery user interface on the display, the alternative delivery option, and
in response to receiving a selection of the alternative delivery option,
generating a second delivery record request comprising the alternative delivery option,
sending the second delivery record to the data delivery management system, and
initiating delivery of the data content to the destination device.

9. The device of claim 1, wherein the memory comprises further instructions that, when executed by the processor, cause the processor to perform further operations comprising presenting, via the data delivery user interface on the display, a collect data delivery option for collect delivery of the data content to the destination device, and the input comprises a selection of the collect delivery option.

10. A data delivery management system comprising:
a processor; and
a memory in communication with the processor, the memory comprising instructions that, when executed by the processor, cause the processor to perform operations comprising
providing a plurality of data delivery options to a source device configured to initiate delivery of data content to a destination device,
receiving a delivery record request from the source device, the delivery record request comprising a selection of a data delivery option from the plurality of data delivery options,
generating a delivery route by which to deliver the data content to the source device, and
sending the delivery route to a data delivery network through which delivery of the data content from the source device to the destination device is to be at least partially performed.

11. The data delivery management system of claim 10, wherein the memory comprises further instructions that, when executed by the processor, cause the processor to perform further operations comprising:
generating a delivery record response; and
sending the delivery record response to the source device.

12. The data delivery management system of claim 11, wherein the delivery record response comprises an instruction to initiate delivery of the data content to the destination device.

13. The data delivery management system of claim 12, wherein the instruction instructs the source device to send the data content to the data delivery network to which the source device is connected.

14. The data delivery management system of claim 12, wherein the instruction instructs the source device to send the data content to the data delivery network via another data delivery network.

15. The data delivery management system of claim 11, wherein the delivery record response comprises a plurality of pricing options for the data delivery option, the memory comprises further instructions that, when executed by the processor, cause the processor to perform further operations comprising receiving, from the source device, a pricing option selected from the plurality of pricing options.

16. The data delivery management system of claim 11, wherein the delivery record request comprises user-defined data delivery specifications, the delivery record response comprises an indication of whether the user-defined data delivery specifications are accepted by the data delivery management system, and the memory comprises further instructions that, when executed by the processor, cause the processor to perform further operations comprising:
if the user-defined data delivery specifications are accepted by the data delivery management system, generating an instruction to initiate delivery of the data content to the destination device and including the instruction in the delivery record response; and
if the user-defined data delivery specifications are not accepted by the data delivery management system, generating an alternative delivery option and including the alternative data delivery option in the delivery record response.

17. A method comprising:
receiving, at a data delivery management system comprising a processor, network performance data;
defining, by the data delivery management system, a plurality of data delivery options based upon the network performance data; and
sending, by the data delivery management system, the plurality of data delivery options to a source device configured to initiate delivery of data content to a destination device.

18. The method of claim 17, further comprising receiving, at the data delivery management system, network policy data, and wherein defining the plurality of data delivery options is further based upon the network policy data.

19. The method of claim 17, further comprising:
receiving, at the data delivery management system, a delivery record request from the source device, the delivery record request comprising a selection of a data delivery option from the plurality of data delivery options;
generating, by the data delivery management, a delivery record response comprising an instruction to the source device to initiate delivery of the data content to the destination device; and
sending, by the data delivery management system, the delivery record response to the source device.

20. The method claim 17, further comprising:
receiving, at the data delivery management system, a delivery record request from the source device, the delivery record request comprising a selection of a data delivery option from the plurality of data delivery options;
generating, by the data delivery management system, a delivery record response comprising a plurality of pricing options for the data delivery option;
sending, by the data delivery management system, the delivery record response to the source device.
